(19) United States
(12) Patent Application Publication
(10) Pub. No.: US 2007/0280431 A1
(43) Pub. Date: Dec. 6, 2007

(54) Messaging System

(76) Inventors: Tobias Alpsten, London (GB); Martin Rowden, London (GB); Arjen Soetekouw, London (GB)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/578,865

(22) PCT Filed: Apr. 20, 2005
(86) PCT No.: PCT/GB05/01491

§ 371 Date: Jul. 3, 2007

(30) Foreign Application Priority Data
Apr. 20, 2004 (GB) 0408773.0

(51) Int. Cl. H04M 11/02

(52) U.S. Cl. 379/38

(57) ABSTRACT

A patient care messaging system comprises a patient administration system on which appointments are administered and a care reminder system. The care reminder system is arranged, before an appointment, to compose and send an electronic message to a patient's telephone which is a reminder of that appointment.

This invention relates to a messaging system, and in particular, such a system for reminding patients of healthcare appointments. This invention also relates to a messaging system, and in particular such a system for reminding patients to administer their medication in accordance with a prescribed regime and to provide motivational support messages during the course of the prescribed regime. Additionally, the invention relates to a messaging system, and in particular, a system for notifying patients that their medication is ready for collection, or that their prescription is ready for collection, especially for repeat prescriptions.

According to recent research, on average 14% of UK patients do not keep their clinic appointments, nearly one third of those non-attendees simply forgetting to turn up. This failure on the part of patients represents a huge cost to healthcare organisations.

By “clinics”, we mean GP's surgeries, hospital departments, outpatient treatment centres, mental health institutions, dentists, therapy centres and any other kind of patient treating healthcare facility or service.

By “text messages”, we mean any form of message delivered to a mobile phone over a mobile communications networks. Currently these types of messages are referred to as SMS or MMS messages.

Specialists argue that solutions that work in some studies, such as telephoning patients with reminders or getting them to make and confirm their own appointments, are unlikely to work long-term across all kinds of outpatient clinics, and are themselves a drain on resources because they require people to be employed with the task of reminding patients of their upcoming appointments.

The problem of patient absenteeism can be reduced without telephoning patients to remind them in advance of their appointments by the use of the present invention. According to a first aspect of the present invention, a patient appointment reminder messaging system comprises: a patient administration system on which appointments are administered; a care reminder system arranged, before an appointment, to compose and send an electronic message to a patient's telephone which is a reminder of that appointment.

Preferably, the electronic message is selected from a mobile telephone text message, an email, and an audio message.

It is also preferred that the care reminder system automatically composes the message, the message including information relating to the appointment.

The system might further include an integration application that extracts appointment information from the patient administration system and transmits it to the care reminder system. In such a case, the message information includes at least one of:
(a) appointment date;
(b) appointment time;
(c) appointment ID;
(d) healthcare site;
(e) name of healthcare practitioner;
(f) practitioner's contact details.
(g) unique patient ID; and
(h) patient's mobile phone number.

The care reminder system might also include a scheduling routine that operates to identify upcoming appointments and prepare appropriate messages.

The system may include a plurality of primary clients through which appointments with primary clients are booked.

When the reminder message is a mobile telephone text message, it is advantageous if the care reminder system includes a reply text message input for receiving replies to text message reminders. The system might then include an e-mail client which sends received replies to text message reminders to a primary client, and it might also include an electronic message handler which automatically handles replies to reminder messages and if appropriate allows for the interpretation of return messages.

The care reminder system can be used to send manual messages and automatic messages which are not reminder messages.

According to a second aspect of the invention, a method of reminding a patient of an appointment comprises: recording the appointment on an electronic appointment system; identifying upcoming appointments; generating an electronic reminder message in respect of each identified upcoming appointment and sending the electronic reminder message to the patient.

This invention comes about by the realisation that the mobile phone (cell phone) penetration of the adult UK population has risen to over 80%, and that penetration is even higher in the 16-34 years age bracket, the group with the highest number of missed appointments. This gives the opportunity to decrease the level of absenteeism in healthcare appointments. As such this solution is expected to significantly reduce the cost of missed appointments for the UK's National Health Service (NHS) and the amount of wasted time for healthcare professionals. Similar improvements are likely to be achieved in healthcare systems around the world.

Sending text message appointment reminders to patients from a non-integrated environment might not be most effective for the healthcare industry because of a constant strain on resources. Healthcare staff do not have the time to re-enter appointment reminders in a system that is not integrated to the process and technology environment of their clinic. Additionally, solutions that are based on just one clinical or patient administration system installed at a single clinic are not ideal either, since the premise of a public health service is to provide an equal level of care and service for all patients. If different clinics implement this system in different ways, or some clinics implement it and others don't, then this might be considered to lead to inequalities in care. Currently, each clinic has its own administration system including a clinical system which contains patient records, and an appointment booking system. These systems are not always integrated.

Additionally, more than half of all patients on regular medication fail to comply with their prescribed regime, and 98% of all failures to comply with the regime are caused by a patient failing to take their medication, often because they forget. Many patients, and in particular those with chronic conditions, are prone to fail to comply with their prescribed regime, and non-compliance with the regime is extremely detrimental to those patients. Most regimes are designed specifically for that patient and can have a very significant effect in proving the patient's health if it is complied with accurately.

Failure to comply with prescribed regimes has a very negative effect on the health and standard of living of such patients and additionally increases the burden on the healthcare system of those patients since they tend to return to their doctors and clinics more frequently because their condition does not improve.

According to a third aspect of the invention, a patient treatment reminder messaging system comprises: a patient care messaging system comprising: a patient administration system on which prescribed treatments are recorded; and a care reminder system arranged to compose and send an electronic message to a patient's telephone at or shortly before a time at which a treatment is due to be carried out and which is a reminder to carry out that treatment.

By sending patients reminder messages, particularly by SMS, the patient is more likely to remember to take his medication and to improve the way in which he complies with the prescribed regime. This should reduce the severity of the condition, increase the patient's standard of living, and reduce that patient's burden on the health system, allowing valuable resources to be committed elsewhere.

The electronic message can be selected from a mobile telephone text message, an e-mail and an audio message. It is also preferred that the care reminder system automatically composes the message, the message including information relating to the treatment.

The system might include any one or more of the following information in the message:
(a) name of medication;
(b) dosage of medication to be taken;
(c) the time at which the medication is to be taken;
(d) the healthcare or pharmacy site;
(e) name of healthcare practitioner or pharmacist;
(f) contact details of practitioner or pharmacist;
(g) unique patient ID; and
(h) patient's mobile telephone number.

When the reminder message is a mobile telephone text message, it is advantageous if the system includes a reply text message input for receiving replies to text messages. The system might then include an e-mail client which sends received replies to text messages to a primary client, and it might also include an electronic message handler which automatically handles replies to reminder messages, and if appropriate allows for the interpretation of returned messages. That way, the patient might be able to reply to confirm that he or she has taken the medication, or to ask questions, perhaps raising queries concerning side effects or difficulties which they are encountering with taking the medication.

The system can also be used to send manual messages and automatic messages which are not reminder messages. Such messages can include motivational support messages.

It is estimated that up to 80% of all repeat prescriptions could be replaced by repeat dispensing schemes not involving the GP. This is calculated to save 2.7 million hours of GP and clinic time in the UK alone. In the UK, it is estimated that 3.2 million GP appointments could be made available by removing unnecessary and cumbersome red tape. Transferring the management of repeat prescriptions to pharmacists and nurses provides a majority of the gains which are available.

According to a fourth aspect of the present invention, a patient care messaging system comprises: a patient care messaging system comprises: a patient administration system on which prescribed treatments are recorded; and a care reminder system arranged to compose and send an electronic message to a patient's telephone informing them of the status of a prescription order.

In this way, reminder messages can be sent to the patient to remind them to collect their medicines, and when their prescription is up for renewal by their GP. Thus, pharmacists can improve their management of the operation of repeat prescription services, and help the patient to remember to pick up their prescriptions, and to renew their prescription with their GP. Thus, improved patient care is achieved.

In view of the penetration of mobile telephones, text messages, such as by SMS, is considered to be a very appropriate medium through which such messages can be sent. However, the electronic message can be selected from a text message, an e-mail and an audio message. It is preferred that the reminder system automatically composes the message, the message including information relating to what is being reminded.

The system might include any one or more of the following pieces of information in the message:
(a) the name of the medication;
(b) the time at which it may be collected from the pharmacy;
(c) the pharmacy site;
(d) the name of the pharmacist;
(e) contact details of the pharmacist;
(f) unique patient ID;
(g) patient's mobile telephone number;
(h) an indication that the prescription must be renewed.

When the reminder message is a mobile telephone message, it is advantageous if the system includes a reply text message input for receiving replies to text messages which have been sent to a patient. The system might then include an e-mail client which sends received replies to text messages to a primary client, and it might also include an electronic message handler which automatically handles replies to reminder messages, and if appropriate allows for interpretation of returned messages. That way, the patient might be able to reply to ask for the opening hours of the pharmacy, or any other question which he or she might have.

The system can also be used to send manual messages and automatic messages which are not reminder messages.

As a consequence, it is advantageous to integrate the invention into a broader patient administration system, which might administer appointments and hold patient records for a cluster of clinics, or even a regional or national grouping of clinics.

Such a patient messaging system would be likely to consist of two modular components. These are:
1. A care reminder system component which identifies when to send out reminder, motivational and informative messages and administers the sending of those messages; and
2. An interface component which connects the care reminder system to the patient administration system to extract appointment information, and in some circumstances, information from the clinical system from it for use by the care reminder system component. In the case of compliance messaging, the interface component extracts treatment information which can be used to send reminders to a patient to take his or her medication. In the case of repeat prescription messaging, the interface component extracts information which can be used to send reminders that repeat prescriptions and/or medications are available for collection.

Embodiments of the invention are described below by way of example only, and with reference to the accompanying drawings in which:

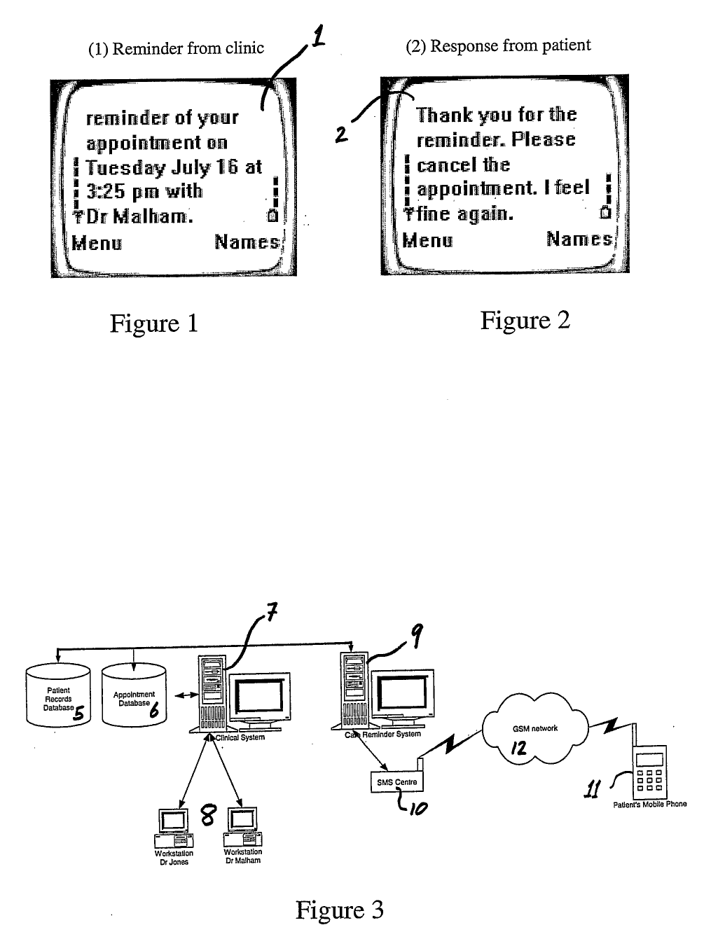

FIG. 1 is a view of a mobile telephone screen displaying an appointment reminder;

FIG. 2 is a view of a mobile telephone screen displaying a reply to an appointment reminder;

FIG. 3 is a block diagram showing one configuration of a patient care messaging system;

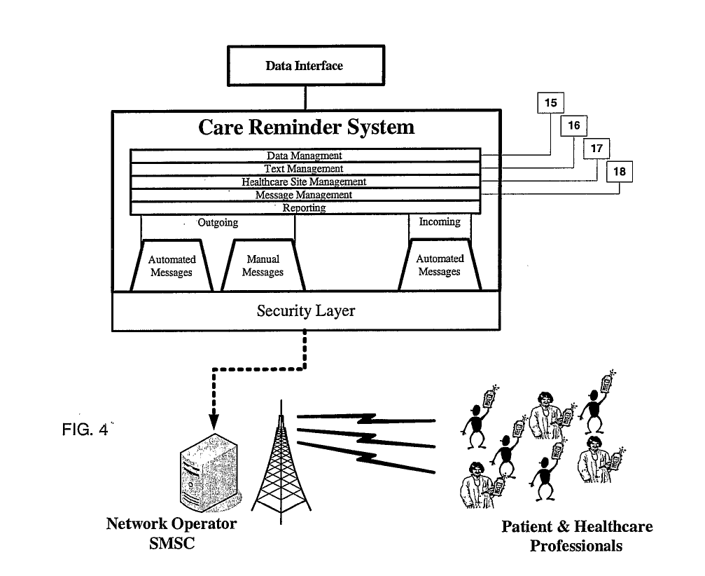

FIG. 4 is a block diagram showing an overview of the reminder system software functionality;

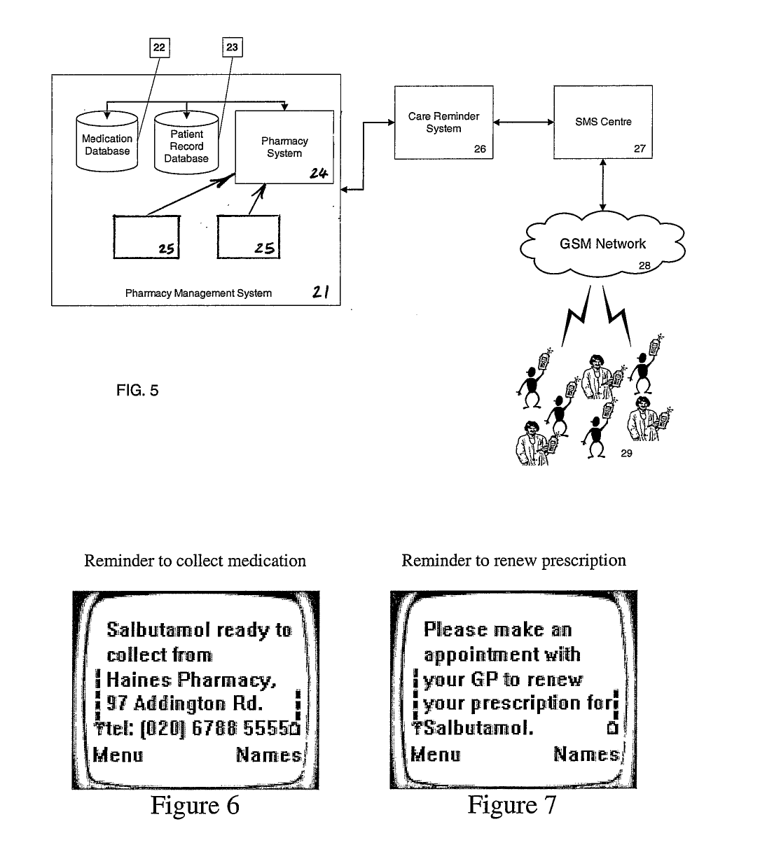

FIG. 5 is a block diagram showing one configuration of a patient care messaging system for reminding a patient to take his or her medication;

FIG. 6 is a view of a mobile telephone screen displaying a reminder to collect a prescribed medication;

FIG. 7 is a view of a mobile telephone screen displaying a reminder to renew a prescription for a medication; and

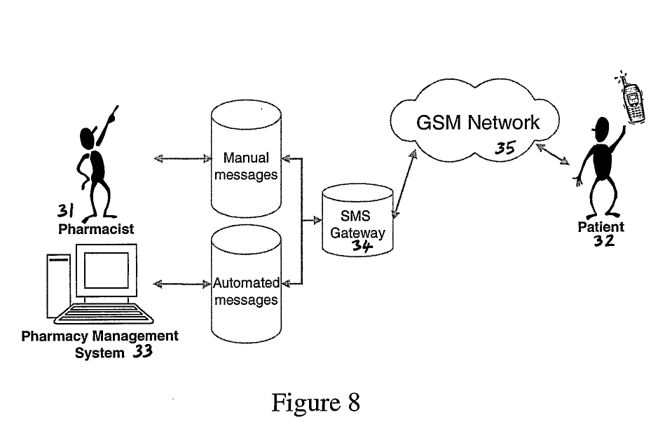

FIG. 8 is a block diagram showing a configuration of a patient care messaging system which can be used by a pharmacist to remind a patient to collect medication or to renew a prescription.

The Patient Care Messaging system is a mobile messaging solution that sends automated text messages to patients' mobile phones, reminding them of their healthcare appointments, of the need to take their medication, that a prescribed medication is ready for collection from a pharmacy, or that a repeat prescription is required from the patient's GP before further medication can be obtained by the patient. The objective of this system is to reduce the level of patient absenteeism, improve the compliance of patients with their prescribed regime of medication or treatment, and to improve the quality of care. The application is designed to integrate with several different clinical and patient administration system products where the patient appointments or treatment information or prescription information reside. As a result of this tight integration to the health service processes and technology, there is no need for human intervention in the reminding process, which prevents the need for additional resources on the operation of the system. In the systems described below, the messaging system actually forms part of the patient and administration system, although it can be operated separately from it.

References to the UK's National Health Service (NHS) in the specification are for convenience only. Other healthcare organisations around the world are relevant to this invention, and the NHS is referred to by way of example only.

In a first embodiment of a patient appointment reminder system, it is necessary to understand how it will operate before describing how it is implemented. Much of the operation is simply an electronic appointment booking system, but the invention gives it significant advantages.
1. The patient books a healthcare appointment at a healthcare site through any of the available means (visit, phone, online, etc.).
2. The appointment is registered on the patient administration system with the doctor, date, time and the patient's details including his/her mobile phone number in the normal course.
3. At a set interval before the patient's appointment (e.g. 3 days in advance and again 24 hours before), the patient receives a text message reminding him/her of the appointment. The text message is sent from a care reminder system, and an example of a typical text message 1 is shown in FIG. 1.
4. After receiving the text message, the patient can choose to do nothing, confirm, reschedule or cancel the appointment by calling the healthcare centre or by replying to the text message. An example of a text message in reply 2 is shown in FIG. 2.

If the patient has confirmed his appointment, he is more likely to present himself the following day in time for the appointment.

The technical implementation will function as follows:
Care appointments will be entered via a workstation in the existing patient administration system, in the usual manner. For best effect, the patient administration system will administer appointments for a cluster of clinics, or even a regional or national grouping of clinics.
A Data Interface either consists of a small application that will be installed onto the existing server that operates the patient administration system or is connected directly to the server through a commercial interface that may or may not be a standard component of the existing patent administration system. At a pre-scheduled interval, for example, every 10 minutes the application extracts all new or amended appointment information that has been entered into the patient administration system. This extracted information is then encrypted and sent (via XML or similar method) to a Care Reminder System.
The Care Reminder System, can be installed in any one of four different ways:
1. Software extension on the patient administration system;
2. Stand alone application server on the healthcare site;
3. Stand alone application server at a remote site managed by the NHS; and
4. Stand alone application server at a remote site managed by a third party. Once the Care Reminder System receives the encrypted information from the data interface, the package is decrypted, verified and the information entered directly into the care reminder system's database.
A text message reminder will be initiated by the care reminder system at a set interval before a scheduled appointment.
The text message will be sent from the care reminder system to a network operator's telecommunications system.
Delivery of text messages will be recorded by the network operator's telecommunications gateway (delivery report from the carrier network). If a message has not been delivered, the care reminder system will repeat the sending for a set period. Message delivery logs will be generated by the care reminder system at a regular interval for reporting purposes.
The patient will receive the reminder as a text message on his mobile phone.
The patient can subsequently choose to:
   Do nothing, in which case the appointment stands.
   Confirm the appointment, in which case the appointment also stands.
   Reschedule the appointment.
   Cancel the appointment.
Cancellation can be achieved in one of three ways:
a. By calling the clinic in which case the changed appointment gets registered on the patient administration system as usual and a copy registration will be sent to the care reminder system;
b. By replying with a text message in which case, and if necessary, the care reminder system will convert the text message to an e-mail and deliver the e-mail to a nominated administrative user of the patient administration system.
c. By replying with a text message in which case the care reminder system allows for the interpretation of return messages. Through the data interface this automatically triggers the required action on the appointments database of the patient administration system (e.g. confirmation, cancel the appointment or change to new date or time), eliminating the need for the administrative staff of the healthcare site to action the return messages.

The technical design of the Patient Care Messaging system is shown in FIG. 3, in which a typical patient administration system is formed by a patient records database 5, an appointments database 6 and a clinical system 7. The clinical system 7 administers the databases. The appointments database 6 is important here because it contains the appointment information for many clinics. The patient records database 5 is less important in this invention, but gives users access to patient medical records. Thus, the clinical system 7 must be very secure, given the nature of the records it administers.

Users book appointments for their patients in their clinics on the appointments database via the clinical system 7. In FIG. 3, these users are indicated as fuctional clinicians 8, Dr Jones and Dr Malham, but are likely to include the staff of such clinicians.

The care reminder system 9 is connected to the appointments database 6, and in some cases the patient records database 5 in order to obtain appointment data for issuing reminder messages. It will be necessary to access the patient records database 5 if there is information there which is to be included in the message, such as the doctor's name, clinic address and the like.

The care reminder system 9 is connected to a network operator's telecommunications gateway 10 through which the messages are routed to patients' mobile telephones 11 via the a mobile communications network 12 such as a GSM or CDMA network.

Based on consultation with several clinical and patient interest groups as well as end user surveys during pilot projects, the patient care messaging system has been designed in order to protect the privacy of individual patients.

Patients will only start to receive reminders of their healthcare appointments, after they have been asked at the moment of making their healthcare appointment whether they object to receiving the text reminders. Should they object to the reminders, their names will be checked on the care reminder system, to be exempted from receiving the text messages.

The application logic of the patient care messaging system resides on the so-called care reminder system. FIG. 4 provides an overview of the software functionality of the care reminder system 8. The care reminder system 8 consists of a number of key modules and these are discussed directly below.

Data Management Module:

The data management module 15 is responsible for retrieving the changed data from the data interface component and for forwarding the patients' return messages to the appropriate e-mail recipients.

Text Management Module:

The text management module 16 is where the healthcare site administrator and end-users (e.g. administrative staff) can manage:
a. standard message body of the appointment reminder that is automatically sent to the patients;
b. other standard messages that are sent occasionally by the healthcare site; and
c. customised messages.

This module also manages the assembly of the appointment reminder from the standard message body and the fields inserted from the data management module.

Healthcare Site Management Module:

In this module 17, healthcare sites using the Patient Care Messaging system can manage:
a. patients registered to receive appointment reminders (including exclusions of people that for clinical or other reasons should not receive these messages);
b. ability to define specific patient groups or groups of healthcare professionals for batch sending; and
c. user access rights
   Message Management Module:

The message management module 18 allows the site administrator to control and set:
a. text messages in the queue;
b. delay and frequency of appointment reminders;
c. daily hours during which appointment reminders may be sent; and
d. e-mail recipient address for return messages.
   Reporting Module:

The reporting module provides audit trails for the following data:
a. text messages sent and delivered;
b. text messages that could not be delivered; and
c. return messages received by the care reminder system 8

The audit trails can be queried for detailed data (e.g. patient and appointment data). It is possible to request a comma delimited export of the reporting data.

Other pertinent points to note about the invention are as follows.

General Access:

The care reminder system can be accessed and managed through web browser interfaces. There is a separate log-in for site administrators (full functionality) and other healthcare staff (user functionality)

Other Automated or Non-Automated Reminders/Alerts:

The care reminder system can easily be extended to include event triggers other than a patient appointment to generate text reminders for patients and healthcare staff. For example, the system could be used to notify patients that their test results are ready for collection or alert healthcare professionals of a major accident in their area. Furthermore, the modular design of the invention includes the addition of non-core messaging modules which allows reminders to be sent as traditional emails or as voice reminders.

E-mail Reminders:

Besides sending text message reminders to patients and healthcare professionals, reminders can be routed to e-mail addresses in certain cases where the recipients can be better reached via e-mail.

Voice Reminders:

Besides sending text message reminders to patients and healthcare professionals, reminders can be routed as voice reminders to those patients that do not have a mobile phone, are unfamiliar with the text messaging functionality or simply prefer to receive voice reminders rather than text messages. This could use a call centre using real people to telephone patients to remind them of upcoming appointments, or could be an automated computer type voice that automatically dials and then delivers an audio message when answered. Such a system can be implemented as with text messages, but with the message routed through an audio system instead of the SMS gateway.

Foreign Language Support:

The United Kingdom is a country with a relatively large percentage of immigrants. The proportion of foreigners in certain British constituencies is particularly high. The modular design of the Care Reminder System includes the ability to send all messages in foreign languages.

Automated Return Messages:

The care reminder system allows for the interpretation of return messages. Through the data interface this automatically triggers the required action on the appointments database (e.g. confirmation, cancel the appointment or change to new date or time), eliminating the need for the administrative staff of the healthcare site to action the return messages.

Treatment Compliance Messaging

FIG. 5 is a block diagram showing a patient care messaging system for helping patients to remember to take their medication. Since the vast majority of failures by patients to comply with their prescribed regime result from an omission to take their mediation, normally because they forget, this system reminds the patient to take their medication on time and may also provide motivational messages to encourage continued compliance. Compliance failure can have a very detrimental effect on the treatment which is received by the patient.

In this case, a pharmacy management system 21 includes a patient records database 22, a medication database 23 and a pharmacy system 24. The pharmacy system 24 administers the databases, not only recording the details of the patients in the patients records database 22, but also the medication and treatment regimes which the patient is currently supposed to be following from the medication database 23. When a prescription is dispensed, the pharmacy management system holds details of what treatments are being administered to which patients. New prescriptions are entered through computers 25 which are operated by pharmacists.

The pharmacy management system 21 is connected to a care reminder system 26, similar to that described in connection with FIG. 3. Periodically, maybe every 10 minutes, details of all new or changed treatments are extracted from the databases 22 and 23 and sent in encrypted form to the care reminder system, which administers medication reminders in a similar way to that described in connection with the system of FIG. 3. However, instead of sending appointment reminders, the care reminder system generates electronic reminders at the time the patient is expected to take the medication which he has been prescribed. Thus, reminders are automatically generated through a tight integration with the pharmacy management system 21. It is preferred that text messages are used, because of the penetration of mobile telephones, but as described in relation to the appointment reminder system, other types of electronic messages could also be used.

The system can also generate random motivational messages from a predefined set of such messages. The system can be set to send out such motivational messages automatically at the same time as the reminder messages, or at such time as prescribed by the system administrator. For example one motivational message might be sent with every fifth reminder message that is sent. Sending such messages is an important part of obtaining compliance by patients in that it makes a big difference in achieving compliance. Some examples might be “Today's tip from your virtual friend: enzymes will help you digest food. Take them with your next meal or snack” or “Today's tip from your virtual friend: using Pulmozyme every day reduces your chances of lung infection by up to 50%!”.

The system can also carry manual text messages and receive text responses from patients and provides convenient functionality for direct interaction between a consultant and his patient, and between a pharmacist and his patient.

Not only will this system improve communication between patients and pharmacists, but patients are likely to adhere much more closely to their medication regimes improving the condition and quality of life of the patient, whilst reducing medicine wastage, and reducing the patient's burden on the healthcare system.

Repeat Prescriptions Messaging

In the UK, all prescriptions have traditionally been issued by doctors, even when they are simply repeat prescriptions for medication which has been prescribed to the patient on a number of occasions before. Increasingly, pharmacists and nurses will take on the task of issuing repeat prescriptions in order to allow doctors to treat more patients. Thus, pharmacists will have a more central role in the treatment of patients than has been the case until now. In some other countries repeat prescriptions are already issued by pharmacists. However, pharmacists currently have limited means for communicating with patients who are registered for repeat prescription services, and this invention seeks to improve that communication.

Central to this invention is the need to notify patients that their medication is ready for collection, or that their prescription requires renewal by their doctor. The system should also be integrated directly into the pharmacy management system, thereby creating minimal operational overheads for the pharmacy.

FIG. 6 shows a typical message which a pharmacist might want to send to a patient explaining that the patient's medication is ready for collection. The message identifies the medication to be collected, the name of the pharmacy, and the contact details of the pharmacy. The sending of such a message can be automated, and can increase the speed at which a patient collects the medication, improves customer contact and quality of service, and improves the healthcare system.

Another reminder message is shown in FIG. 7 where the pharmacist is unable to dispense any further medication until the prescription has been renewed by the patient's doctor. Again, this can be an automated message, and assists the patient in giving him the information which he needs in order to obtain more of the medication.

FIG. 8 is a block diagram showing the way in which the system would work, and is, in effect, very similar to the system shown in FIG. 5 for compliance messaging.

In FIG. 8, the pharmacist 31 will want to inform the patient 32 that the medication which has been prepared for him is ready for collection. The pharmacist's pharmacy management system 33 will automatically send a message to the patient. Firstly, an automatic message is generated and this is passed to the SMS gateway 34 where it can be sent via a GSM network 35 to the patient's mobile telephone. Alternatively, a pharmacist may wish to send other information to the patient by way of a manual message through the SMS gateway 34 to the patient 32, which is also possible. In the same way as with the compliance messaging, the information required is extracted from the pharmacy management system 33 to a care reminder system which generates the manual and automated messages and sends them to the patient.

As will be appreciated, both the compliance messaging and the repeat prescription messaging can be integrated together so as to perform both functions.

Additionally, it will be appreciated that many of the features of the appointment reminder messaging system will apply to the compliance messaging and repeat prescription messaging systems.

It will be appreciated that in all of the embodiments described above, the messaging is sent to the patient in a form such that the patient can receive it and read the message without having to have any special apparatus. A normal mobile telephone is sufficient. For example, it is not necessary for the patient to have locally installed applications or software specific to the messaging system that is used. Additionally, a patient does not need to set the messaging systems up himself, since these are all generated from the primary client. Thus, the patient does not need to send his personal information, treatment information or appointment information to a third party since this is all held on the primary client's system.

Additionally, it will be understood from the foregoing that the patient is not receiving an information channel of aggregated information, but is receiving specific messages relating to an appointment, a treatment, or the availability of a prescription.

1. A patient care messaging system comprising:
a patient administration system on which appointments are administered;
a care reminder system arranged, before an appointment, to compose and send an electronic message to a patient's telephone which is a reminder of that appointment.

2. A system according to claim 1, wherein the electronic message is selected from a mobile telephone text message, an email, and an audio message.

3. A system according to claim 1, wherein the care reminder system automatically composes the message, the message including information relating to the appointment.

4. A system according to claim 3, wherein the message information includes at least one of:
(a) appointment date;
(b) appointment time;
(c) appointment ID;
(d) healthcare site;
(e) name of health care practitioner;
(f) practitioner's contact details;
(g) unique patient ID; and
(h) patient's mobile phone number.

5. A system according to claim 1 further including an integration application that extracts appointment information from the patient administration system and transmits it to the care reminder system.

6. A system according to claim 1, wherein the care reminder system includes a scheduling routine that operates to identify upcoming appointments and prepare appropriate messages.

7. A system according to claim 6, wherein the patient administration system includes an appointment database on which appointments are recorded, and wherein the scheduling routine operates to identify all appointments booked since the previous scheduling operation was executed.

8. A system according to claim 6, wherein the scheduling routine is arranged to transfer data on new appointments to the care reminder system.

9. A system according to claim 1, further including a plurality of primary clients through which appointments with primary clients are booked.

10. A system according to claim 1 wherein, when the reminder message is a mobile telephone text message, the care reminder system includes a reply text message input for receiving replies to text message reminders.

11. A system according to claim 10, including an e-mail client which sends received replies to text message reminders to a primary client.

12. A system according to claim 1, further including an electronic message handler which automatically handles replies to reminder messages and if appropriate allows for the interpretation of return messages.

13. A system according to claim 1 wherein the care reminder system can be used to send manual messages and automatic messages which are not reminder messages.

14. A method of reminding a patient of an appointment, comprising:
recording the appointment on an electronic appointment system;
identifying upcoming appointments;
generating an electronic reminder message in respect of each identified upcoming appointment and sending the electronic reminder message to the patient.

15. A method according to claim 14, wherein the electronic reminder message is generated as any one of a mobile telephone text message, an email message, and an audio message.

16. A method according to claim 14, wherein generating the reminder message is done automatically, and includes information relating to the appointment.

17. A method according to claim 14, wherein the message information includes at least one of:
(a) appointment date;
(b) appointment time;
(c) appointment ID;
(d) healthcare site;
(e) name of healthcare practitioner;
(f) practitioner's contact details;
(g) unique patient ID; and
(h) patient's mobile phone number.

18. A method according to claim 12, further comprising identifying upcoming appointments in a batch process.

19. A patient care messaging system comprising:
a patient administration system on which prescribed treatments are recorded; and
a care reminder system arranged to compose and send an electronic message to a patient's telephone at or shortly before a time at which a treatment is due to be carried out and which is a reminder to carry out that treatment.

20. A system according to claim 19, wherein the treatment that is the subject of the reminder is the administering of a medication.

21. A system according to claim 19, wherein the electronic message is a mobile telephone text message, an e-mail, or an audio message.

22. A system according to claim 19, wherein the care reminder system automatically composes the message, the message including information relating to the treatment.

23. A system according to claim 22, wherein the message information includes at least one of:
(a) name of medication;
(b) dosage of medication to be taken;
(c) the time at which the medication is to be taken;
(d) the healthcare or pharmacy site;
(e) name of healthcare practitioner or pharmacist;
(f) contact details of practitioner or pharmacist;
(g) unique patient ID; and
(h) the patient's mobile telephone number.

24. A system according to claim 19, further including an integration application that extracts patient and treatment information from the patient administration system and transmits it to the care reminder system.

25. A system according to claim 24, wherein the patient administration system includes a patient database on which data on the patient is recorded and a treatment database on which treatments for different medications are stored.

26. A system according to claim 24, wherein the integration application operates periodically to identify all new treatments which have been prescribed to a patient and transmits the relevant data to the care reminder system.

27. A system according to claim 19, further including a plurality of primary clients through which treatments are prescribed.

28. A system according to claim 19, wherein, when the reminder message is a mobile telephone text message, the care reminder system includes a reply text message input for receiving replies to text message reminders.

29. A system according to claim 28, including an e-mail client which sends received replies to text message reminders to a primary client.

30. A system according to claim 19, further including an electronic message handler which automatically handles replies to reminder messages and if appropriate allows for the interpretation of returned messages.

31. A system according to claim 19, wherein the care reminder system can be used to send manual messages and automatic messages which are not reminder messages.

32. A method of reminding a patient to take a treatment, comprising recording the treatment on an electronic data system;
identifying upcoming treatments;
generating an electronic reminder message m respect of each identified upcoming treatment and sending the electronic reminder message to the patient.

33. A patient care messaging system comprising:
a patient administration system on which prescribed treatments are recorded; and
a care reminder system arranged to compose and send an electronic message to a patient's telephone informing them of the status of a prescription order.

34. A system according to claim 33, wherein the electronic message is selected from a mobile telephone text message, an e-mail and an audio message.

35. A system according to claim 33, wherein the care reminder system automatically composes the message, the message including information relating to the treatment.

36. A system according to claim 35 wherein the information is information on the repeat prescription or prescribed substance availability.

37. A system according to claim 33, wherein the message information includes at least one of:
(a) name of medication;
(b) the healthcare or pharmacy site;
(c) name of the healthcare practitioner or pharmacist;
(d) contact details of practitioner or pharmacist;
(e) unique patient ID; and
(f) the patient's mobile telephone number.

38. A system according to claim 33, further including an integration application that extracts patient treatment information from the patient administration system and transmits to the care reminder system.

39. A system according to claim 2:
wherein the care reminder system automatically composes the message, the message including information relating to the appointment;
wherein the message information includes at least one of:
(a) appointment date;
(b) appointment time;
(c) appointment ID;
(d) healthcare site;
(e) name of health care practitioner;
(f) practitioner's contact details;
(g) unique patient ID; and
(h) patient's mobile phone number;
further including an integration application that extracts appointment information from the patient administration system and transmits it to the care reminder system;
wherein the care reminder system includes a scheduling routine that operates to identify upcoming appointments and prepare appropriate messages;
wherein the patient administration system includes an appointment database on which appointments are recorded, and wherein the scheduling routine operates to identify all appointments booked since the previous scheduling operation was executed;
wherein the scheduling routine is arranged to transfer data on new appointments to the care reminder system;
further including a plurality of primary clients through which appointments with primary clients are booked;
wherein, when the reminder message is a mobile telephone text message, the care reminder system includes a reply text message input for receiving replies to text message reminders;
including an e-mail client which sends received replies to text message reminders to a primary client;
further including an electronic message handler which automatically handles replies to reminder messages and if appropriate allows for the interpretation of return messages; and
wherein the care reminder system can be used to send manual messages and automatic messages which are not reminder messages.

40. A method according to claim 15:
wherein generating the reminder message is done automatically, and includes information relating to the appointment;
wherein the message information includes at least one of:
(a) appointment date;
(b) appointment time;
(c) appointment ID;
(d) healthcare site;
(e) name of healthcare practitioner;
(f) practitioner's contact details;
(g) unique patient ID; and
(h) patient's mobile phone number; and
further comprising identifying upcoming appointments in a batch process.

41. A system according to claim 20:
wherein the electronic message is a mobile telephone text message, an e-mail, or an audio message;
wherein the care reminder system automatically composes the message, the message including information relating to the treatment;
wherein the message information includes at least one of:
(a) name of medication;
(b) dosage of medication to be taken;
(c) the time at which the medication is to be taken;
(d) the healthcare or pharmacy site;
(e) name of healthcare practitioner or pharmacist;
(f) contact details of practitioner or pharmacist;
(g) unique patient ID; and
(h) the patient's mobile telephone number;
further including an integration application that extracts patient and treatment information from the patient administration system and transmits it to the care reminder system;
wherein the patient administration system includes a patient database on which data on the patient is recorded and a treatment database on which treatments for different medications are stored;
wherein the integration application operates periodically to identify all new treatments which have been prescribed to a patient and transmits the relevant data to the care reminder system;
further including a plurality of primary clients through which treatments are prescribed;
wherein, when the reminder message is a mobile telephone text message, the care reminder system includes a reply text message input for receiving replies to text message reminders;
including an e-mail client which sends received replies to text message reminders to a primary client;
further including an electronic message handler which automatically handles replies to reminder messages and if appropriate allows for the interpretation of returned messages;
wherein the care reminder system can be used to send manual messages and automatic messages which are not reminder messages.

42. A system according to claim 34, wherein the care reminder system automatically composes the message, the message including information relating to the treatment;
wherein the information is information on the repeat prescription or prescribed substance availability;
wherein the message information includes at least one of:
(a) name of medication;
(b) the healthcare or pharmacy site;
(c) name of the healthcare practitioner or pharmacist;
(d) contact details of practitioner or pharmacist;
(e) unique patient ID; and
(f) the patient's mobile telephone number; and
further including an integration application that extracts patient treatment information from the patient administration system and transmits to the care reminder system.
